(19) United States
(12) Patent Application Publication
(10) Pub. No.: US 2003/0093301 A1
(43) Pub. Date: May 15, 2003

(54) Centralized clinical data management system process for analysis and billing

(75) Inventors: Charles F. Chesney, Sunfish Lake, MN (US); Kevin A. Petrucelli, Maplewood, MN (US)

Correspondence Address: Sehwegman, Lundberg, Woessner & Kluth, P.A., P.O. Box 2938, Mineapolis, MN, 55402, US

(73) Assignee: Hypertension Diagnostics, Inc.

(21) Appl. No.: 10/008,782

(22) Filed: Nov. 13, 2001

(51) Int. Cl. G06F 17/60

(52) U.S. Cl. 705/3

(57) ABSTRACT

Method and apparatus for acquiring and analyzing signals to generate medical data pertinent to one or more individuals and storing the data in a local machine, then collecting the medical data to a centralized system for further analysis and/or creation of invoices for billing. Some embodiments include a medical-data collection apparatus for processing an arterial blood pressure waveform to extract clinically useful information on the state of the cardiovascular system of an individual. After storing medical data for one or more individuals, the medical-data collection apparatus establishes communications with a centralized information-processing system, uploads its data, and is re-enabled to collect further data. The information-processing system optionally generates bills or invoices for the services based on usage of each of the medical-data collection apparatus, and optionally aggregates the data from a plurality of individuals for further analysis.

### FIELD OF THE INVENTION

This invention relates to the field of medical data collection, and more specifically, to a method and apparatus for acquiring and analyzing signals to generate medical data for one or more individuals and storing the data in a local machine, then collecting the medical data to a centralized facility for further analysis (e.g., aggregate analysis of overall populations or subpopulations) and/or creation of invoices for billing.

### BACKGROUND OF THE INVENTION

U.S. Pat. No. 5,211,177 (incorporated herein by reference) discloses method and apparatus for measuring properties of the human vasculature using an electrical analog model of vascular impedance. These properties include the compliance of large and small vessels, and systemic resistance. These measurements and others obtained from the model can in turn be used to diagnose states of health or disease, and to assess the effectiveness of treatment regimes. For example, see Finkelstein S. M., Collins V. R., Cohn J. N., Arterial vascular compliance response to vasodilators by Fourier and pulse contour analysis, Hypertension 1988:12:380-387, the entire disclosure of which is incorporated herein by reference.

While the approach taught in U.S. Pat. No. 5,211,177 produces useful results, it has been a goal to continue to perfect and improve waveform analysis including gathering and analyzing data from large and varied populations. It is further a goal to widely provide medical analysis machines with low initial cost and customized billing based on usage. To this end, a number of areas for improvement have been identified and presented herein.

### SUMMARY OF THE INVENTION

One aspect of the present invention provides an apparatus and a method for gathering, analyzing, and/or invoicing a fee for the use or service provided by a digitized physiological measurement. One embodiment includes a computer system programmed to carry out the method of: i) receiving and storing information in a measurement device identifying an individual and information specifying one or more medical parameters of the individual, ii) controlling the measurement device to obtain a digitized physiological measurement of the individual, iii) establishing a communications link between the measurement device and a central information-processing system, iv) transferring to and storing in the central information-processing system the information identifying the individual, the information specifying one or more medical parameters of the individual, and the digitized physiological measurement of the individual, v) storing, in the central information-processing system, information identifying the measurement device, vi) terminating the communications link between the measurement device and a central information-processing system. For each of a plurality of individuals, the method further includes creating, in the central information-processing system, a first invoice including a billing charge for the physiological measurement of each one of the individuals. This invoice includes delivery information correlated to the information identifying the measurement device. Thus, an invoice can be generated for, and addressed to, each institution having such a measurement device. Each invoice can include patient identification and an associated billing charge, a date of the procedure, in order that the central information-processing system collects information from all measurement devices, then bills each institution, and each institution can then pass on the billing portions to the patients using its measurement device. This allows distribution of the measurement devices with little or no up-front costs, while later collecting nominal fees based on usage of the measurement devices.

Another aspect of the invention includes apparatus for gathering and analyzing a digitized physiological measurement. This apparatus includes a reception device that receives data sent from each of a plurality of remote measurement devices, the data including at least one measurement taken by each respective remote device, a database operatively coupled to the reception device and configured to store a plurality of measurement records, each one of the records corresponding to one or more individual measurements, and an invoicing system operatively coupled to obtain records from the database and operable to create a first invoice including a first billing charge for a first measurement taken by a first remote measurement device and a second billing charge for a second measurement take by a second remote measurement, wherein each invoice includes delivery information correlated to information identifying the respective first or second measurement device.

### BRIEF DESCRIPTION OF THE DRAWINGS

FIG. 1 shows a computerized system 100 for uploading information.

FIG. 2 shows a measurement device 200 for obtaining medical information.

FIG. 3 shows an overview of measurement device 300.

FIG. 4 shows an overview of an information-processing system 400.

FIG. 5 shows an overview of some of the functions of the invention.

FIG. 6 shows an overview of some others of the functions of the invention.

FIG. 7 shows an overview of data records used to hold data for some embodiments of the invention.

### DESCRIPTION OF PREFERRED EMBODIMENTS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

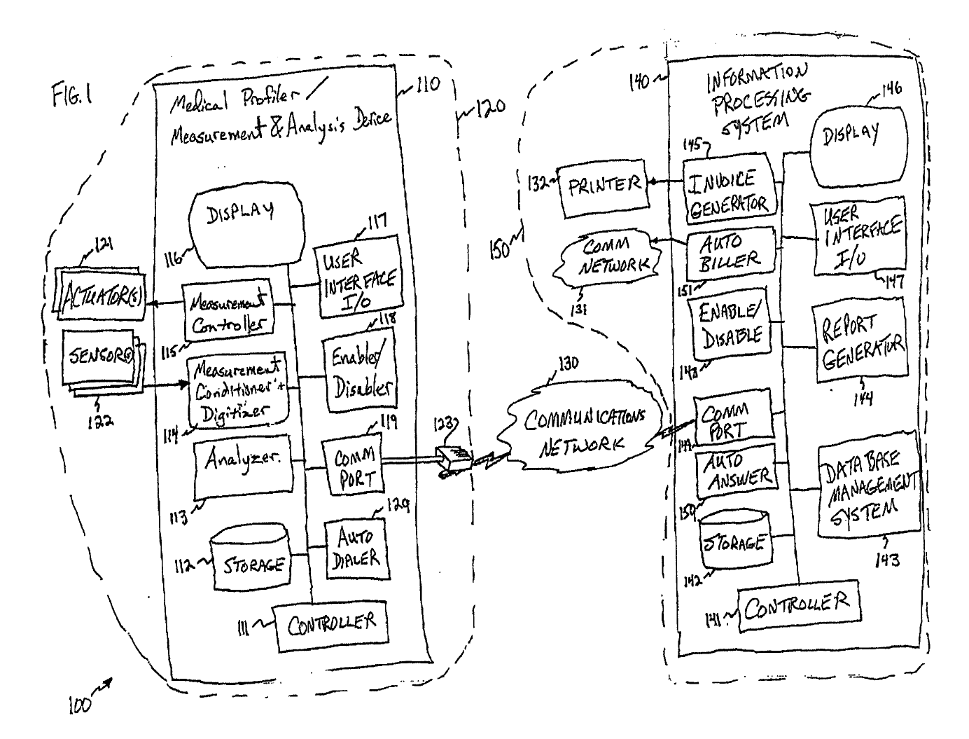

FIG. 1 shows a computerized system 100 for uploading and analyzing information, and for billing for services rendered by the system. In some embodiments, system 100 includes one or more measurement devices 120 and a centralized information-processing facility (also called a central data management facility or CDMF) 150 (that includes one or more information-processing systems 140). Remote that are selectively connected to one another across communications network 130. In some embodiments, measurement device 120 includes a medical profiler device 110 (e.g., a cardiovascular profiling instrument such as the model DO-2020 device available from Hypertension Diagnostics Incorporated) that can be plugged into the plain old telephone system (POTS) using a standard telephone cable 123. In other embodiments, device 120 is implemented as other types of remote data-collection devices for which communications initiated by the remote device 120 to a central data management facility 150 is desired, e.g., for the purpose of data collection from the remote device 120, billing for the use(s) of remote device 120, replacing the software of remote device 120, and/or re-enabling continued functioning of the remote device 120. In some embodiments, intermediate data collection facilities 150 are provided, each of which is substantially similar to CDMF system 150 in servicing incoming communications from a group of remote devices 120, but which in turn each periodically communicate to a master CDMF 150 much as the remote devices 120 communicate to the intermediate CDMFs 150.

In some embodiments, medical profiler 110 includes a controller 111, storage unit 112, analyzer unit 113, conditioner and digitizer unit 114, measurement controller unit 115, display 116, user interface input/output unit 117, enabler/disabler unit 118, communications port 119, and autodialer unit 129. In some embodiments, some or all of the various functional units just described are implemented in stored program code executed by controller 111. Some embodiments include one or more externally connected actuators 121 that provide stimulus for the sensing operations (for example, outputting compressed air for an oscillometric cuff) and one or more externally connected sensors 122 that produce analog or digital signals for the measurement (for example, an arterial-pulse-pressure-waveform signal). In some embodiments, personal information about the particular consumer is entered through user interface I/O 117. E.g., in a medical environment, this might include a patient's name, address, social security or patient-ID number, height, weight, gender, age, race, and/or medical history information. This personal information could be typed into a keyboard or touch screen, or downloaded from the medical facilities computer system, or read from a personal medical information card carried by the patient. The measurement signal obtained from sensors 122 is conditioned (e.g., amplified and/or filtered) and digitized by sensing unit 114, and the resulting stream of digital values for some period of time is stored in storage 112 (in some embodiments, a disk drive). Analyzer unit 113 then performs an analysis of the stored measurements and produces a result (also called a report) based on the analysis of the stored measurements and stores that result into storage 112. The result can also be displayed on display 116 and/or printed to paper and/or communicated to a user's office computer or terminal (e.g., to a doctor in her office at a remote location from the measurement device and the patient being monitored).

In some embodiments, enabler/disabler unit 118 provides a limited-use enablement of the functions and features of measurement device 120. For example, in some embodiments, only a certain predetermined number of measurements and/or analyses (e.g., one or ten measurements) could be made and stored into storage 112 before the machine 110 is partially or fully disabled. In other embodiments, measurements could only be made for a certain period of time (e.g., one or ten days) before the machine 110 is partially or fully disabled. Then, the device 120 would have to be connected to facility 150 and allowed to upload its information. Information-processing system 140, upon successful completion of the upload operation, would download an authorization code or other appropriate information to re-enable the functions of device 120 until the next upload was needed (e.g., a code needed to re-enable five more measurements or five more day's usage). Optionally, the download also includes updates to the stored program code in device 120. This enablement function encourages or forces the user of device 120 to upload its collected information for the centralized information processing system 140 to use in further analysis of the data, and in generating invoices for the use made of device 120 and others like it, and to download programming updates to maintain the latest and best functionality into device 120. In some embodiments, the enablement code is made to work only with the newest programming code download, such that downlevel programming code is incompatible with the new enablement codes. In some embodiments, the enablement unit also requires a date code (e.g., downloaded to device 120 or provided by an internal clock unit (not shown) in device 120) in device 120 to be within a predetermined range for the enablement function to work. This helps prevent operation of device 120 using old programming code downloads and old enablement codes.

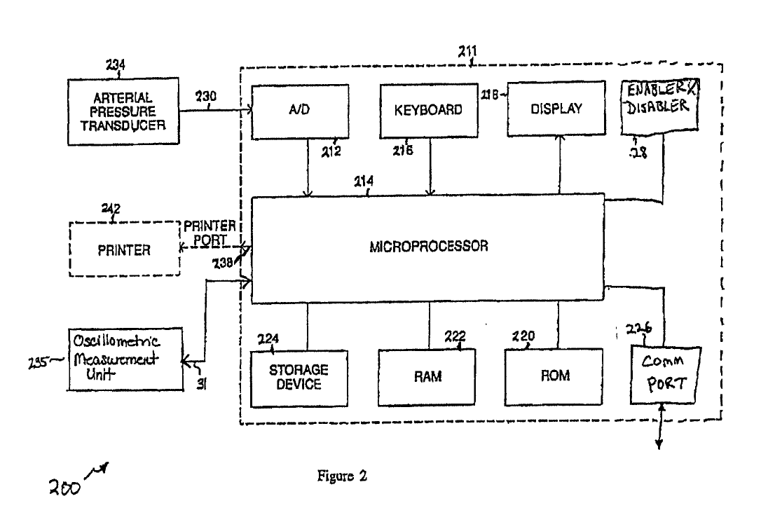

In some embodiments, measurement device 120 is a cardiovascular profiler instrument 200 such as described in FIG. 2 and its description below.

In some embodiments, information-processing system 140 includes a controller 141, storage unit 142, database management system (DBMS) unit 143, report generator unit 144, invoice generator unit 145, display 146, user interface input/output unit 147, enabler/disabler unit 148, communications port 149, and autoanswer unit 159, and auto-biller unit 151. In some embodiments, some or all of the various functional units just described are implemented in stored program code executed by controller 141. Some embodiments include one or more externally connected communications networks 131 that provide billing information to financial institutions to have the users automatically pay the invoices electronically. In some embodiments, communications network 131 is used to communicate data to a master CDMF 150 that collects data from a plurality of intermediate CDMFs 150. Some embodiments include one or more printers 132 that print paper invoices to be mailed to users of devices 120.

In some embodiments, communications network 131 includes a connection to the internet, wherein doctors or other health-care researchers can sign-on from remote locations and perform database queries of the data stored in storage 142 using DBMS 143. Such queries can include, for example, demographic or population studies that extract data about certain populations of patients, examine long-term outcomes for populations having certain characteristics or who are measured as having certain characteristics (such as particular ranges of arterial compliance, or other characteristic blood-pressure waveform features).

In some embodiments, measurement device 120 obtains one or more blood-pressure waveforms over time, and derives arterial compliance parameters therefrom. The healthcare practitioner also gathers various patient-history data about the patient and enters this into device 120.

According to the present invention, measurement device 120 periodically establishes a communications link to facility 150 across communications network 130. In some embodiments, for example, a predetermined telephone number is stored in autodialer 129, and a direct telephone connection is made from measurement device 120 (sometimes also called a doctor's-office device 120, or just DO 120) called to that telephone number, which is connected to communications port 149 of information-processing system 140. E.g., controller 111 causes a telephone call to be made to a toll-free (e.g., a 1-800-type toll-free telephone number) and a modem in communications port 119 establishes a data-communications link to a modem in communications port 149. In other embodiments, device 120 is connected (via a local-area network or a modem) to the internet, and establishes communications to a particular internet address corresponding to system 150.

In some embodiments, the information-processing system 140 includes two Compaq-brand communications servers to receive such phone calls from the DO measurement devices 120. In other embodiments, one or more communications servers are used. In other embodiments, one ore more internet e-mail servers is/are used in place of, or in addition to, the communications server(s), in order to receive e-mails, from suitably configured DO measurement devices 120, that include the patient data and measurement information described below as being received by the communications servers. A software program in each communications server (or email server) waits for a call (or email), answers the call, validates that a valid DO serial number is presented by the remote DO 120. In some embodiments each DO 120 has its records stored in a fifty-entry array (i.e., the array holds up to fifty (50) records), which also marks which records have been sent previously. The unsent records are then sent by the DO 120 and received by information-processing system 140, and information-processing system 140 sends confirmation back to the DO device 120 that the data was received (i.e., which records were received). The DO 120 then tags each one of the old records (those just sent) with an indication of the confirmation, so those records are not sent again. In some embodiments, the DO 120 has a rolling 50-record array, with a end-around wrap, so the oldest records are overwritten one at a time once 50 measurements have been taken. Thus, the health-care professional can review the most-recent 50 patients and their measurements from the DO 120. For older measurements, the doctor or health-care professional can interface into information-processing system 140 through a secure internet interface, and can access any record of any past measurement. Further, some embodiments allow the health-care professional to do remote internet-based database inquiries of the entire database, not accessing individually identifiable patient information, but rather accessing aggregations of data selected by some attribute(s) of a population.

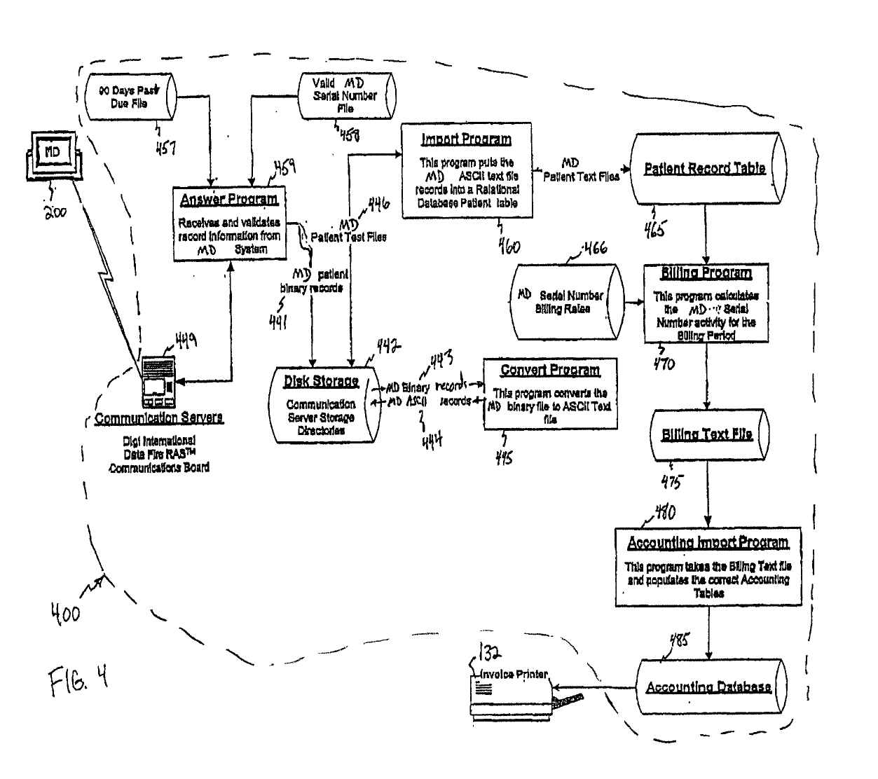

In some embodiments, a Microsoft-brand SQL-type database software program running in system 140 unwraps each received record (which when sent by DO 120 is in an encoded binary format), converts the data to a tab-delimited text file record. Each text record is imported into a DB (database) table, one example of which is patient record table 465 (see FIG. 4 below). A software program in system 140 then performs a billing function every night. The billing function uses a separately specified billing profile for each customer (each DO 120 serial number can specify a different billing rate table (in some embodiments, this is implemented as different billing rates in a single table), with potentially different charges for various measurements made by a particular DO 120, and potentially different tables of charges for different DO serial numbers). At end of month, a software program in system 140 creates invoice for each customer (i.e., an invoice is created for each DO serial number, and if a single customer possesses a plurality of DO 120 devices, their invoices are aggregated and sent, or, in other embodiments, are individually sent).

In some embodiments, the DB table is also used for patient profiling, and population profiling. As described above, such summary data is available to doctors and others who sign-in to an internet web site having access to the DB table. In some embodiments, various analysis functions can be specified by the doctor to obtain various reports from the DB table 465, such as the remote user (e.g., a doctor) inputting various characteristics defining a population of patients, and obtaining summary data, trend data, and/or range data, etc., regarding measurements taken of that population.

In some embodiments, connection between remote device 120 and system 150 is made across the internet using, e.g., TCP/IP protocols or e-mail or other suitable communications protocols. In such embodiments, each of one or more DO measurement devices 120 is configured to automatically establish an internet connection (such as by a modem connected to a telephone line, or by a network-interface card (NIC) connected to a local-area network that has internet access), and to upload the patient data and information records. Data is then uploaded from measurement device 120 into facility 150 (e.g., a device identifier unique to measurement device 110, the personal consumer data, the results data generated by analyzer 113 and/or digitized waveforms generated by digitizer 114). In some embodiments, a re-enablement code is then transmitted to device 120, and optionally a program-code download (e.g., a program patch or modification to improve the operation of the DO measurement device 120) is also transmitted to device 120. The communications link is then disconnected (e.g., the telephone connection is hung up). Optionally, in some embodiments, these communications are accomplished through the exchange of one or more e-mail packages of data. In some embodiments, an encrypted mode of communications is used.

Referring to FIG. 2, there is illustrated a simplified example of a cardiovascular profiler measurement device system 200 for measuring vascular compliance, and usable with system 100. In the embodiment shown, measurement device 200 includes a transducer unit 234, an oscillometric cuff blood pressure measurement unit 235, a computer system 211, and a printer 242. System 211 includes an analog to digital converter (A/D) 212, (in one embodiment, one having 16-bit resolution), and a micro-processor unit 214, for example a S-MOS Cardio I/O, 486-type 75 MHz processor (available from S-MOS Systems, Inc., of San Jose, Calif.), a keyboard or similar input device 216 such as a touch-sensitive screen and corresponding user interface, a display 218 such as a Planar™ electroluminescent display (available from Planar Systems, Inc., of Beaverton, Oreg.), a ROM or flash ROM 220, a RAM 222, and a storage device 224 such as a disk drive. An input port 230 is provided to receive analog signal input from an arterial pressure transducer unit 234. In addition, there is provided an input/output port 231 for data received from an oscillometric cuff blood pressure measurement device 235 and for control to the cuff device 235. In some embodiments, microprocessor 214 includes an output port 238 connected to optional printer 242. System 211 also includes a communications port 226 for uploading data and/or receiving enablement codes from a centralized information-processing facility including an information processing system 140 (see FIG. 1).

In some embodiments, transducer unit 234 and related accessories are those shown in commonly assigned U.S. Pat. No. 6,159,166, entitled “Sensor and Method for Sensing Arterial Pulse Pressure” and filed Mar. 20, 1998, and U.S. Pat. No. 6,132,383, entitled “Apparatus and Method for Holding and Positioning an Arterial Pulse Pressure Sensor,” and U.S. Pat. No. 6,017,313, entitled “Apparatus and Method for Blood Pressure Pulse Waveform Contour Analysis,” the contents of these patent applications being incorporated herein by reference. Oscillometric cuff pressure measurement unit 235 is, in some embodiments, an OEM blood pressure module, such as those sold by Colin Medical Instruments, Inc., of San Antonio, Tex.

Other alternative means of measuring the arterial waveform are disclosed in U.S. Pat. No. 5,211,177. Moreover, the arterial waveform may also be obtained invasively, if desired, although this is not believed to be preferred from a cost, medical risk and patient and healthcare professional convenience perspective, using, for example, a Statham P23Db pressure transducer as unit 234. If obtained invasively, preferably, such a transducer would be connected to a patient's brachial or radial artery via an 18-gauge, 2-inch Teflon catheter. This catheter-transducer system should have an undamped natural frequency higher than 25 Hz and a damping coefficient less than 0.5, providing an acceptable frequency response. It shall be understood, however, that while the brachial or radial artery is preferred, other central or peripheral arterial locations for obtaining the blood pressure waveforms can be substituted.

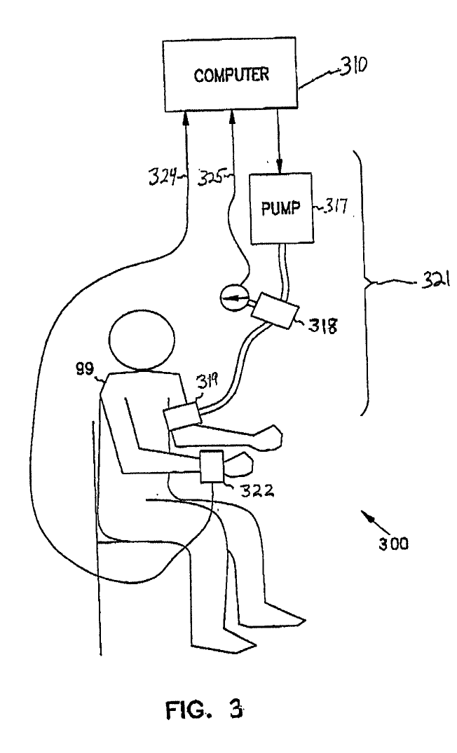

Referring to FIG. 3, there is shown an overview of measurement device 300 used in some embodiments of the invention. System 300 includes an oscillometric sensor 321 and a tonometric sensor 322, both coupled to computer 320. Tonometric sensor 322 provides tonometric signal 324 to computer 320. In one embodiment, tonometric signal 324 is an analog signal that is sampled and analog-to-digital converted by computer 320 at a fixed sampling rate (e.g., two hundred samples per second) to provide a series of digital values representing the pressure measured at the radial artery of patient 99. Oscillometric sensor 321 includes cuff 319, pressure sensor 318, and pump 317 controlled by computer 310, and generates oscillometric signal 325. Pump 317 provides both inflation and deflation finctions. In one embodiment, oscillometric signal 325 is an analog signal that is sampled and analog-to-digital converted by computer 310 at a fixed sampling rate (typically fifty samples per second) to provide a series of digital values representing the gauge pressure of the cuff surrounding the brachial artery of patient 99 as the relatively steady pressure on the cuff 319 is varied by pump 317. Using both oscillometric signal 325 and tonometric signal 324, computer 310 can better calibrate the signals and the analysis.

Referring to FIG. 4, there is illustrated an overview of an information-processing system 400 used, in some embodiments, for information-processing system 140. In some embodiments, system 400 includes a communications port 449, an answer program 459 with an associated ninety-days past-due file 457 and valid-measurement-device-serial-number file 458, storage unit 442, binary-to-ASCII conversion program 445, import program 460, patient record table 465, measurement-device-serial-number billing-rate table 466, billing program 470, billing text file 475, accounting import program 480, and accounting database 485. Invoice printer 132 is connected as also shown in FIG. 1.

In some embodiments, communications port 449 includes one or more Data Fire RAS™ communications boards available from Digi International Corporation of Minnetonka, Minn. (www.dgii.com). Answer program 459 receives and validates the recorded results information from the measurement device (MD) 200 that has telephoned to communications port 449. In some embodiments, measurement device 200 is one of a plurality of similar devices that telephone to the same telephone number and communications port 449. In other embodiments, measurement device 200 is used for device 120 in the system of FIG. 1. In some embodiments, the measurement device 200 is one of a plurality of quite different devices, each of which uploads quite different data that is processed according to different rules and procedures, and placed in separate files. In either case, each measurement device 200 includes its own serial number (e.g., a different unique serial number for each device) and optionally a device type or model number, which are checked using the data in valid-measurement-device-serial-number file 458. In some embodiments, ninety-days past-due file 457 is used to determine whether the user who possesses this particular measurement device 200 is current in paying their invoices or is instead more than ninety days late with one or more payments. If the serial number is validated and the customer is current with payments, answer program 459 then downloads a re-enablement code to measurement device 200; else measurement device 200 is left as is (e.g., disabled for one or more of its functions). In some embodiments, measurement device 200 may include some free or vital functions (such as life support functions), which are always left enabled, and other functions that are selectively disabled (such as non-critical analysis and report functions) that are disabled after some predetermined amount of use or time (which may or may not vary from time to time). Thus, to keep measurement device 200 in a running condition, the user must allow it to connect to system 400 on a regular basis. This allows system 400 to obtain usage information and uploaded analysis data (such as patient identification, medical histories, and/or cardiovascular analysis data (e.g., vasular compliance numbers for large vessels and small vessels, and cardiac output, as well as a recorded arterial pulse waveform for one or more beats, or an averaged waveform combining a plurality of beats)) and to optionally to download software updates for device 200.

In some embodiments, the data collected in the DO measurement device 120 and uploaded into central data management facility 150 includes fields as specified in Table 1.

TABLE 1

| field name | data type | tested for |
|---|---|---|
| DO-2020 Software Revision Number | char (10) | NOT NULL |
| DO-2020 Serial Number | char (15) | NOT NULL |
| Subject ID | char (25) | NOT NULL |
| Date Of Birth | datetime | NOT NULL |
| Study Date Time | datetime | NOT NULL |
| Gender | char (1) | NOT NULL |
| Height | smallint | NOT NULL |
| Weight | smallint | NOT NULL |
| Caucasian | yes/no | NOT NULL |
| African American | yes/no | NOT NULL |
| Hispanic | yes/no | NOT NULL |
| Native American | yes/no | NOT NULL |
| Asian | yes/no | NOT NULL |
| Other Race | yes/no | NOT NULL |
| Diabetes | yes/no | NOT NULL |
| Cardiovascular Disease | yes/no | NOT NULL |
| Hypertension | yes/no | NOT NULL |
| Heart Failure | yes/no | NOT NULL |
| Heart Attack | yes/no | NOT NULL |
| Stroke | yes/no | NOT NULL |
| Renal Disease | yes/no | NOT NULL |
| High Lipids | yes/no | NOT NULL |
| Arteriosclerosis | yes/no | NOT NULL |
| Arteritis | yes/no | NOT NULL |
| Other Disease | yes/no | NOT NULL |
| Relative Cardiovascular Disease | yes/no | NOT NULL |
| Relative Hypertension | yes/no | NOT NULL |
| Relative Heart Failure | yes/no | NOT NULL |
| Relative Heart Attack | yes/no | NOT NULL |
| Relative Stroke | yes/no | NOT NULL |
| Relative Renal Disease | yes/no | NOT NULL |
| Relative Diabetes | yes/no | NOT NULL |
| Relative Arteriosclerosis | yes/no | NOT NULL |
| Relative High Lipids | yes/no | NOT NULL |
| Relative Other Disease | yes/no | NOT NULL |
| Cardiovascular Medications | yes/no | NOT NULL |
| Beta Blockers | yes/no | NOT NULL |
| Diuretic | yes/no | NOT NULL |
| Ace Inhibiters | yes/no | NOT NULL |
| Calcium Channel Blocker | yes/no | NOT NULL |
| Alpha-Blocker | yes/no | NOT NULL |
| Angiotensin II Blocker | yes/no | NOT NULL |
| Nitrate Compound | yes/no | NOT NULL |
| Lipid Lowering Agent | yes/no | NOT NULL |
| Other Cardiovascular Medicines | yes/no | NOT NULL |
| Menopause | char (1) | NOT NULL |
| Hormone R Therapy | char (1) | NOT NULL |
| Tobacco Use | yes/no | NOT NULL |
| Cigarette Use | yes/no | NOT NULL |
| Cigar Use | yes/no | NOT NULL |
| Pipe Use | yes/no | NOT NULL |
| Chew use | yes/no | NOT NULL |
| Cigarette Count | smallint | NOT NULL |
| Alcohol Use | yes/no | NOT NULL |
| Beer Use | yes/no | NOT NULL |
| Wine Use | yes/no | NOT NULL |
| Cocktail Use | yes/no | NOT NULL |
| Unaltered Liquor Use | yes/no | NOT NULL |
| Alcohol Count | smallint | NOT NULL |
| Systolic | smallint | NOT NULL |
| Diastolic | smallint | NOT NULL |
| MAP | smallint | NOT NULL |
| Pulse Pressure | smallint | NOT NULL |
| Pulse Rate | smallint | NOT NULL |
| Signal Strength | smallint | NOT NULL |
| Body Surface Area | decimal (9, 2) | NOT NULL |
| Body Mass Index | decimal (9, 2) | NOT NULL |
| Large Artery Elasticity Index | decimal (9, 2) | NOT NULL |
| Small Artery Elasticity Index | decimal (9, 2) | NOT NULL |

In other embodiments, the data collected in the DO measurement device 120 and uploaded into central data management facility 150 includes fields as specified in Table 2.

TABLE 2

| field name | data type | tested for |
|---|---|---|
| Software_Revision_Number | char (10) | NOT NULL, |
| Serial_Number | char (15) | NOT NULL, |
| Subject_ID | char (25) | NOT NULL, |
| Date_Of_Birth | datetime | NOT NULL, |
| Study_Date_Time | datetime | NOT NULL, |
| Gender | char (1) | NOT NULL, |
| Height | smallint | NOT NULL, |
| Weight | smallint | NOT NULL, |
| Caucasian | bit | NOT NULL, |
| African-American | bit | NOT NULL, |
| Hispanic | bit | NOT NULL, |
| Native-American | bit | NOT NULL, |
| Asian | bit | NOT NULL, |
| Other_Race | bit | NOT NULL, |
| Diabetes | bit | NOT NULL, |
| Cardiovascular_Disease | bit | NOT NULL, |
| Hypertension | bit | NOT NULL, |
| Heart_Failure | bit | NOT NULL, |
| Heart_Attack | bit | NOT NULL, |
| Stroke | bit | NOT NULL, |
| Renal_Disease | bit | NOT NULL, |
| High_Lipids | bit | NOT NULL, |
| Arteriosclerosis | bit | NOT NULL, |
| Arthritis | bit | NOT NULL, |
| Other_Disease | bit | NOT NULL, |
| Rels_with_Cardiovascular_Disease | smallint | NOT NULL, |
| Relatives_with_Hypertension | bit | NOT NULL, |
| Relatives_with_Heart_Failure | bit | NOT NULL, |
| Relatives_with_Heart_Attack | bit | NOT NULL, |
| Relatives_with_Stroke | bit | NOT NULL, |
| Relatives_with_Renal_Disease | bit | NOT NULL, |
| Relatives_with_Diabetes | bit | NOT NULL, |
| Relatives_with_Arteriosclerosis | bit | NOT NULL, |
| Relatives_with_High_Lipids | bit | NOT NULL, |
| Relatives_with_Other_Disease | bit | NOT NULL, |
| Cardiovascular_Medications | bit | NOT NULL, |
| Beta_Blockers | bit | NOT NULL, |
| Diuretic | bit | NOT NULL, |
| Ace_Inhibitor | bit | NOT NULL, |
| Calcium_Channel_Blocker | bit | NOT NULL, |
| Alpha_Blocker | bit | NOT NULL, |
| Angiotensin_II_Blocker | bit | NOT NULL, |
| Nitrate_Compound | bit | NOT NULL, |
| Lipid_Lowering_Agent | bit | NOT NULL, |
| Other_Cardiovascular_Medicines | bit | NOT NULL, |
| Menopause | char (1) | NOT NULL, |
| Hormone_Replacement_Therapy | char (1) | NOT NULL, |
| Tobacco_Use | bit | NOT NULL, |
| Cigarette_Use | bit | NOT NULL, |
| Cigar_Use | bit | NOT NULL, |
| Pipe_Use | bit | NOT NULL, |
| Chew_Use | bit | NOT NULL, |
| Cigarette_Count | smallint | NOT NULL, |
| Alcohol_Use | bit | NOT NULL, |
| Beer_Use | bit | NOT NULL, |
| Wine_Use | bit | NOT NULL, |
| Cocktail_Use | bit | NOT NULL, |
| Unaltered_Liquor_Use | bit | NOT NULL, |
| Alcohol_Count | smallint | NOT NULL, |
| Systolic | smallint | NOT NULL, |
| Diastolic | smallint | NOT NULL, |
| MAP | smallint | NOT NULL, |
| Pulse_Pressure | smallint | NOT NULL, |
| Pulse_Rate | smallint | NOT NULL, |
| Signal_Strength | smallint | NOT NULL, |
| Body_Surface_Area | decimal (9, 2) | NOT NULL, |
| Body_Mass_Index | decimal (9, 2) | NOT NULL, |
| Large_Artery_Elasticity_Index | decimal (9, 2) | NOT NULL, |
| Small_Artery_Elasticity_Index | decimal (9, 2) | NOT NULL, |

In some embodiments, answer program 459 outputs its data 441 to disk storage 442 in the form of MD binary records 443. Convert program 445 reads these MD binary records 443, and converts the data to ASCII (American Standards for Computer Information Interchange) format, and outputs MD ASCII records 444 back to storage 442. Import program reads MD patient test files 446 (including the MD ASCII records 444) and inserts them into a relational database patient record table 465. In some embodiments, billing program 470 reads the usage information from patient record table 465, and using data from MD serial number billing rates table 466, calculates invoice values for the activity/usage of each serial-numbered machine. In some embodiments, different billing rates are charged, wherein billing rates are a function of the contract terms negotiated with each user or medical facility for each respective measurement device, the amount of usage (e.g., more usage obtains lower rates), patient or provider-specific information (e.g., rates can depend on terms contracted to certain health-care providers, or on insurance coverage), and/or other factors. Billing program 470 outputs its results to billing text file 475. In some embodiments, only an aggregate cost is attributed to each machine. In other embodiments, a total cost, as well as an itemized list showing a patient identification (a patient name, or an anonymous patient identifier can be used) and a cost for each patient, in order to facilitate the medical institution that receives the invoice in their passing the cost on to their consumers.

Accounting program reads the data from the billing text file 475 and populates the correct accounting tables with the billing information, and outputs its results to accounting database 485. In some embodiments, accounting database 485 is a standardized format used by an off-the-shelf accounting program (not shown) to print the output invoices to paper using printer 132.

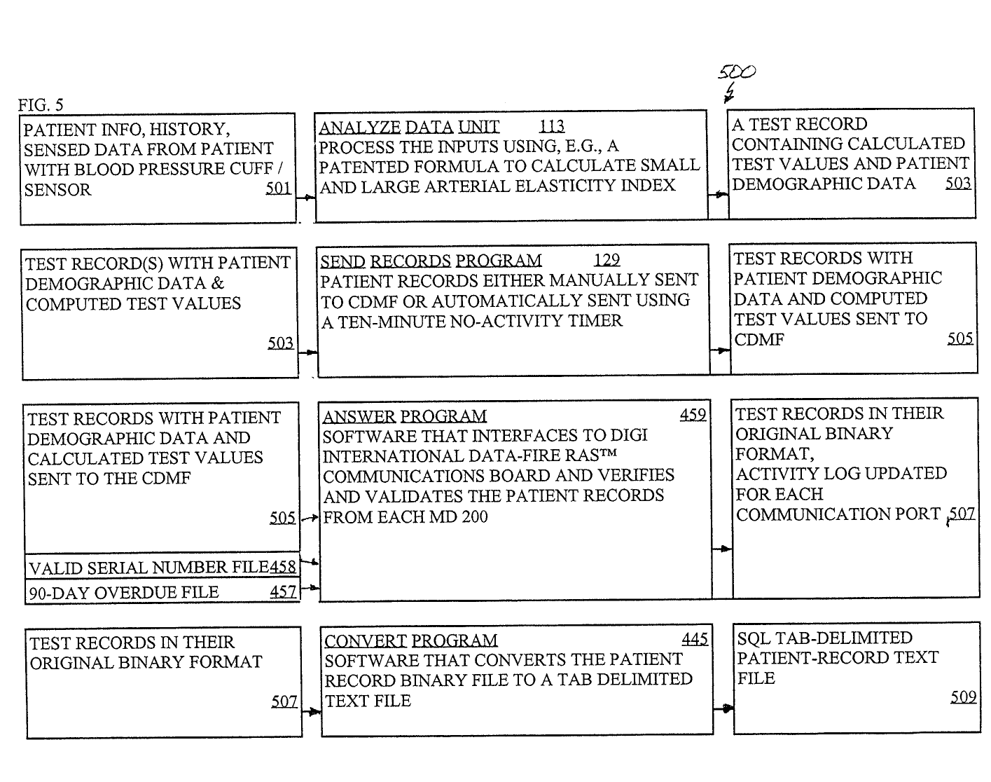

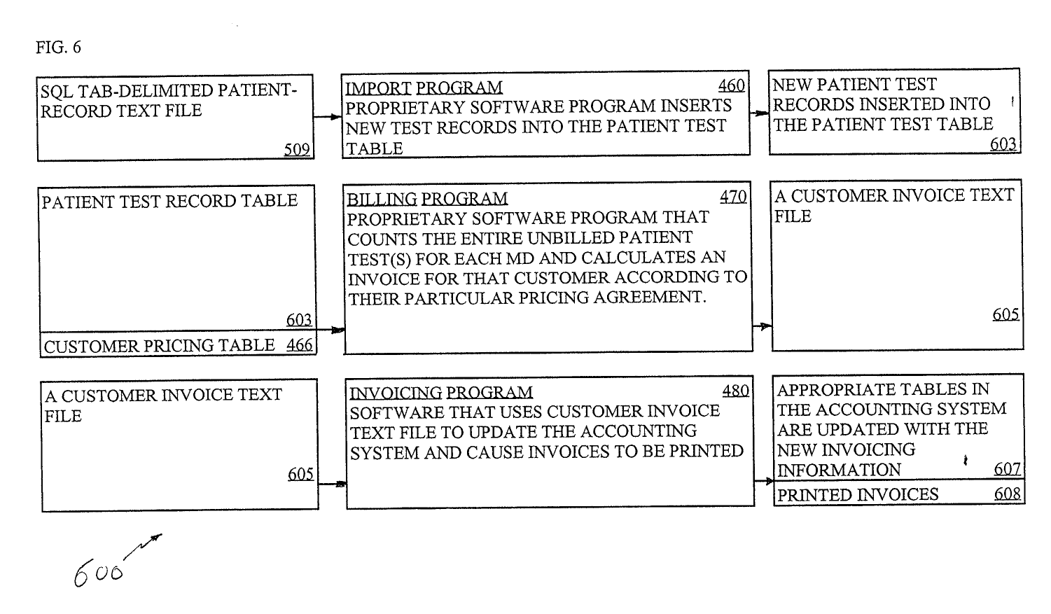

FIGS. 5 and 6 shows the inputs, functions, and outputs of the programs used in some embodiments of FIG. 1 and FIG. 4. At block 501, a health-care provider such as a doctor obtains patient information (such as height, weight, whether the patient smokes or drinks alcohol, etc.), and patient history (such as relatives with various diseases, past illnesses), and enters this into the touch-screen entry device on DO device 120. DO device 120 then obtains sensed data from patient measured with a blood-pressure cuff and wrist arterial-pressure sensor as described in commonly assigned U.S. Pat. No. 6,159,166, entitled “Sensor and Method for Sensing Arterial Pulse Pressure” and filed Mar. 20, 1998, and U.S. Pat. No. 6,132,383, entitled “Apparatus and Method for Holding and Positioning an Arterial Pulse Pressure Sensor.” At block 113, according to some embodiments, the input data from block 501 are processed to calculate small and large arterial elasticity indices as described in U.S. Pat. No. 6,017,313, entitled “Apparatus and Method for Blood Pressure Pulse Waveforrn Contour Analysis.” The outputs at block 503 include a Test Record Containing Calculated Test Values and Patient Demographic Data. The output data of block 503 are then sent (as one or more records) from the DO device 120 to system 140 and used as input parameters to Send Records Program 129, described above. The patient records are sent either as a result of a manually entered command to the DO device 120, or are sent by DO device 120 automatically using, e.g., a ten-minute no-activity timer (when the machine has not been used for a given period of time, it telephones system 140). The Test Records with Patient Demographic Data and Computed Test Values are being sent to system 140 at block 505. These test records of block 505 are then input values, wherein answer program 459 answers the incoming telephone call. In some embodiments, program 459 is software that interfaces to Digi International Data-fire Ras™ Communications Board and verifies the serial number of DO device 120 and validates the patient records from each DO device 120 (e.g., measurement device MD 200). The test records are transmitted and received in their original binary format, and an Activity Log is updated for each communication port activity (e.g., each telephone call). In some embodiments, a Valid Serial Number File 458 is used to verify the serial number of the incalling DO device 120, and a 90-day Overdue File 457 (indicating, e.g., which customers are 90 days late in paying their bills). In some embodiments, the system performs these tests on the records in their original binary format. The binary records 507 (in some embodiments, these are the binary records 443 of FIG. 4) are then used as inputs to Convert Program 445, which is software that converts the patient record binary file to a tab-delimited text file, and outputs an SQL-type tab-delimited patient-record text file 509 (in some embodiments, these are the ASCII records 444 of FIG. 4).

FIG. 6 shows further processing. The output tab-delimited patient-record text file 509 becomes input to Import Program 460. This is any suitable software program that inserts new test records into a suitable patient test table 603. The Patient Test Record Table 603 is then input to billing program 470, which is any suitable software program that counts the entire unbilled patient test(s) for each MD 200 (or other DO device 120) and calculates an invoice entry for that customer according to their particular pricing agreement. This then outputs a Customer Invoice Text File 605. In some embodiments, a Customer Pricing Table 466 provides one or more different pricing formulas such that each customer can have one of a number of different pricing schedules. The Customer Invoice Text File 605 is then used as input to Invoicing Program 480, which is software that uses customer invoice text file to update the accounting system and cause invoices to be printed. Its output includes updates to appropriate tables in the accounting system with the new invoicing information 607, and/or printed invoices 608. In some embodiments, invoices are sent electronically to each customer (e.g., via e-mail) for convenience and speed.

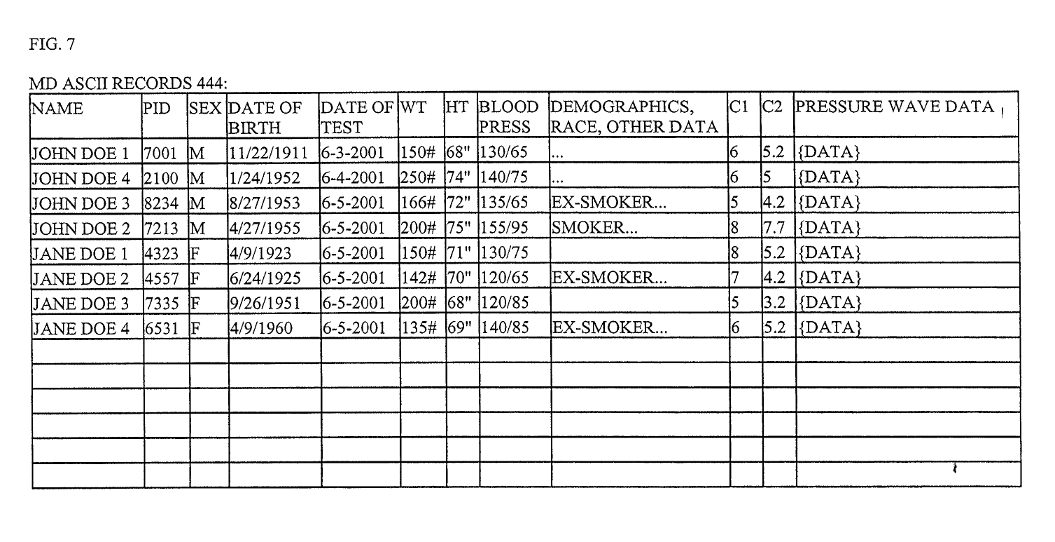

FIG. 7 shows exemplary MD ASCII Records 444 as stored on system 140. In this embodiment, each record includes patient's name (optionally), a machine identifier (MID), a patient identifier (PID), the patient's gender, age ,weight, height, blood pressure (systolic and diastolic, as measured by the cuff of DO device 120), demographics, elasticity parameters c1 and c2, and at least one waveform of pressure wave data.

FIG. 7 shows an overview of DB table 700 having a plurality of data records used to hold measurement record data for some embodiments of the invention.

Modified Windkessel Model

As noted above, one example embodiment of the measurement device of present invention uses the modified Windkessel model of the vasculature, and produces as output, the values C₁, C₂ and L, with R being calculated from mean arterial pressure and cardiac output. How compliance values, mean arterial pressure, or cardiac output are determined is not essential to the inventions claimed herein and is therefore not discussed further. However, method and apparatus for obtaining these measurements are described in U.S. Pat. No. 5,211,177 entitled “Vascular Impedance Measurement Instrument,” U.S. Pat. No. 5,241,966 entitled “Method and Apparatus for Measuring Cardiac Output,” U.S. Pat. No. 6,159,166 entitled “Sensor and Method for Sensing Arterial Pulse Pressure,” U.S. Pat. No. 6,132,383 entitled “Apparatus and Method for Holding and Positioning an Arterial Pulse Pressure Sensor,” U.S. Pat. No. 6,017,313 entitled “Apparatus and Method for Blood Pressure Pulse Waveform Contour Analysis,” the entire disclosures of which are herein incorporated by reference.

Conclusion

Thus, there is described herein above a method and apparatus for blood pressure waveform analysis, upload and billing.

One aspect of the present invention provides an apparatus for gathering and analyzing a digitized physiological measurement. This apparatus includes a computer system programmed to carry out the method of: i) receiving and storing information in a measurement device identifying an individual and information specifying one or more medical parameters of the individual, ii) controlling the measurement device to obtain a digitized physiological measurement of the individual, iii) establishing a communications link between the measurement device and a central information-processing system, iv) transferring to and storing in the central information-processing system the information identifying the individual, the information specifying one or more medical parameters of the individual, and the digitized physiological measurement of the individual, v) storing, in the central information-processing system, information identifying the measurement device, vi) terminating the communications link between the measurement device and a central information-processing system. For each of a plurality of individuals, the method further includes creating, in the central information-processing system, a first invoice including a billing charge for the physiological measurement of each one of the individuals. This invoice includes delivery information correlated to the information identifying the measurement device. Thus, an invoice can be generated for, and addressed to, each institution having such a measurement device. Each invoice can include patient identification and an associated billing charge, a date of the procedure, in order that the central information-processing system collects information from all measurement devices, then bills each institution, and each institution can then pass on the billing portions to the patients using its measurement device. This allows distribution of the measurement devices with little or no up-front costs, while later collecting nominal fees based on usage of the measurement devices.

In some embodiments of the apparatus, the computer system is programmed to carry out the further method of, after obtaining a predetermined number of physiological measurements of individuals into the measurement device, blocking one or more functions of the measurement device until information is transferred to the central information-processing system, and then once information is transferred to the central information-processing system, re-enabling the one or more functions of the measurement device. This can prevent unauthorized usage of the measurement devices, and ensures that the data collected by the measurement devices is collected for aggregate analysis over numerous measurement devices, patient populations, geographical regions, or other criteria. If the institution having possession of some particular measurement device is not paying their invoice, one or more functions of their machine can be cut off from being re-enabled pending payment. In some embodiments, the measurement device's data must be uploaded to the central information-processing system after each use (i.e., only one patient's information can be stored, and that must be uploaded before the measurement device can again be used). In other embodiments, up to a predetermined plurality of patient measurements can be stored (e.g., data for five usages or five patients) before the measurement device must upload its data else risk being disabled. In yet other embodiments, a predetermined time period is used; e.g., the measurement device will attempt to establish communications once every twenty-four hours (for example, at 3 AM, to reduce long-distance charges or communications traffic congestion), then after some time period of unsuccessful attempts (for example, if the measurement device is not connected to a telephone line), one or more one or more functions of the measurement device will be disabled. In some embodiments, after each communication link is established the central information-processing system will conditionally download into the measurement device an authorization to perform an additional predetermined number of procedures (e.g., five more measurements), or an authorization to function for an additional predetermined period of time (e.g., five more days of measurements).

In some embodiments of the apparatus, the measurement device further includes an arterial-pulse-pressure sensor, wherein the digitized physiological measurement performed by the measurement device includes acquiring a digitized arterial-pulse-pressure waveform and computing one or more calculated compliance parameters, based on the arterial-pulse-pressure waveform, for a model of the vascular system of a human.

Some embodiments of the apparatus further include a plurality of measurement devices, wherein computer system is programmed to carry out the further method of creating, in the central information-processing system, a separate invoice for each one of the plurality of measurement devices, each invoice including a billing charge and a patient identification for each physiological measurement.

Another aspect of the present invention provides a computerized system for uploading information to an information-processing system. This computerized system includes a first machine. The first machine includes an input port operable to obtain digital information about a first consumer, an analyzer operable to automatically analyze the digital information to generate a first analysis report for the first consumer, based on the digital information, and an upload communications port operable to automatically, based on the generation of the first analysis report, establish a communications link to the information-processing system and to upload information from the first analysis report to the information-processing system, and then to disconnect the communications link.

Some embodiments of the system further include an arterial-pulse-pressure sensor operably coupled to the input port in the first machine, wherein the digital information includes a digitized arterial-pulse-pressure waveform, the first analysis report includes one or more calculated compliance parameters, based on the arterial-pulse-pressure waveform, for a model of the vascular system of a human, and the uploaded information includes the calculated compliance parameters.

Some embodiments of the system further include the information-processing system configured to establish the communications link in response to a request from the first machine and to receive the upload information from the first analysis report to the information-processing system, and to generate a first invoice associated with the first machine for use of the first machine.

Some embodiments of the system further include an information-processing system, and a second machine. The second machine (like the first machine) includes an input port operable to obtain digital information about a second consumer, an analyzer operable to automatically analyze the digital information to generate a second analysis report for the second consumer, based on the digital information, and an upload communications port operable to automatically, based on the generation of the second analysis report, establish a communications link to the information-processing system and to upload information from the second analysis report to the information-processing system, and then to disconnect the communications link. In some of these embodiments, the information-processing system is configured to establish the communications link in response to a request from the first machine and to receive the upload information from the first analysis report to the information-processing system and to generate a first invoice associated with the first machine for use of the first machine, and to establish the communications link in response to a request from the second machine and to receive the upload information from the second analysis report to the information-processing system and to generate a second invoice associated with the second machine for use of the second machine.

Yet another aspect of the present invention provides a method that includes the following functions: establishing a first temporary communications link in response to a request from a first remote machine, receiving upload information from the first remote machine to the information-processing system, the upload information including a first analysis report generated by the first machine, disconnecting the first communications link, establishing a second temporary communications link in response to a request from a second remote machine, receiving upload information from the second remote machine to the information-processing system, the upload information including a second analysis report generated by the second machine, disconnecting the second communications link, aggregating the information of the first analysis report and the information of the second analysis report for an overall analysis, generating a first invoice associated with the first machine for use of the first machine, and generating a second invoice associated with the second machine for use of the second machine.

Some embodiments of the method further include sensing a first arterial pulse pressure waveform of a first person and storing a digitized representation of the first arterial pulse pressure waveform in the first remote machine, analyzing the digitized representation of the first arterial pulse pressure waveform to calculate one or more compliance parameters, based on the arterial pulse pressure waveform, for a model of the first person's vascular system, wherein the upload information from the first remote machine includes the one or more compliance parameters of the first person. These embodiments also include sensing a second arterial pulse pressure waveform of a second person and storing a digitized representation of the second arterial pulse pressure waveform in the second remote machine, and analyzing the digitized representation of the second arterial pulse pressure waveform to calculate one or more compliance parameters, based on the arterial pulse pressure waveform, for a model of the second person's vascular system, wherein the upload information from the second remote machine includes the one or more compliance parameters of the second person.

Another aspect of the present invention provides a computer system programmed to carry out one or more of the methods just described.

Still another aspect of the present invention provides a computerized method for billing for analysis services including (a) obtaining digital information for a first consumer into a first analysis system, (b) analyzing the digital information in the first analysis system to produce an analysis report for the first consumer, (c) establishing communications between the first analysis system and an information-processing system, (d) uploading information from the analysis report from the first analysis system to the information-processing system, and (e) generating, in the information-processing system, a first invoice for one or more charges associated with use of the first analysis system.

Some embodiments further include (f) obtaining digital information for a second consumer into a second analysis system, (g) analyzing the digital information in the second analysis system to produce an analysis report for the second consumer, (h) establishing communications between the second analysis system and the information-processing system, (i) uploading information from each of the one or more analysis reports from the second analysis system to the infornation-processing system, and 0) generating, in the information-processing system, a second invoice for charges associated with use of the second analysis system.

In some embodiments of this method, the digital information further includes demographic information regarding each one of the respective consumers (or patients), and a representation of an arterial pulse pressure waveform of the respective consumer. The analysis report includes one or more calculated compliance parameters, based on the arterial pulse pressure waveform, for a model of the vascular system of a human. The method further includes (k) generating, in the information-processing system, a summary report that shows an analysis combining information uploaded from the analysis report from the first analysis system with information uploaded from the analysis report from the second analysis system. This allows larger studies of patients and the possible correlation of various demographic or medical histories or future medical outcomes to the measurement and/or analysis of the measurement. For example, white males having a particular medical history and a particular measurement and/or analysis of the measurement provided by the measurement device, might be predicted to have a certain life expectance or likelihood of a heart attack within a certain time period. Data collected by numerous machines for numerous patients can be classified and sorted to confirm, modify, or refute such a hypothesis.

In some embodiments of this method, the digital information includes a representation of an arterial pulse pressure waveform of a person, and the analysis report includes one or more calculated compliance parameters, based on the arterial pulse pressure waveform, for a model of the vascular system of the person.

In some embodiments of this method, the digital information represents an arterial pulse pressure waveform of a person, and the analysis report includes a representation of the arterial pulse pressure waveform.

In some embodiments of this method, the first invoice includes an identifier for the first consumer and an associated charge for their use of the first analysis system.

In some embodiments of this method, the digital information represents an arterial pulse pressure waveform, and the analysis report includes one or more calculated compliance parameters, based on the arterial pulse pressure waveform, for a model of the vascular system of a person, and wherein the first invoice includes an identifier for the first consumer and an associated charge for their use of the first analysis system.

Some embodiments further include (1) disabling one or more functions of the first analysis system after a predetermined amount of use of the first analysis system, and (m) re-enabling the one or more finctions of the first analysis system upon successful completion of uploading of the information from the first analysis system to the information-processing system.

Another aspect of the invention includes an apparatus for gathering and analyzing a digitized physiological measurement. This apparatus includes a reception device that receives data sent from each of a plurality of remote measurement devices, the data including at least one measurement taken by each respective remote device, a database operatively coupled to the reception device and configured to store a plurality of measurement records, each one of the records corresponding to one or more individual measurements, and an invoicing system operatively coupled to obtain records from the database and operable to create a first invoice including a first billing charge for a first measurement taken by a first remote measurement device and a second billing charge for a second measurement take by a second remote measurement, wherein each invoice includes delivery information correlated to information identifying the respective first or second measurement device.

It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled. In particular, the invention(s) is not limited to application to human patients and subjects, and may also be used for animals. As such, the invention is generally applicable for use on all mammals which exhibit blood pressure waveforms to which the present invention may be applied. Furthermore, the invention(s) is not restricted to any particular model of the human vasculature, but has applicability to any model, electrical, fluid, mechanical or otherwise, that involves analysis of physiological parameters. Further, the invention(s) is not limited to physiological measurements, and may also be used for other services for consumers that are performed by remote machines such as banking or financial advice machines, ticket sales machines, CD or DVD replication machines, book publishing machines, etc.

What is claimed is:

1. Apparatus for gathering and analyzing a digitized physiological measurement comprising a computer system programmed to carry out the method of:
a) for a first individual,
i) receiving and storing information in a measurement device identifying an individual and information specifying one or more medical parameters of the individual;
ii) controlling the measurement device to obtain a digitized physiological measurement of the individual;
iii) establishing a communications link between the measurement device and a central information-processing system;
iv) transferring to and storing in the central information-processing system the information identifying the individual, the information specifying one or more medical parameters of the individual, and the digitized physiological measurement of the individual;
v) storing, in the central information-processing system, information identifying the measurement device;
vi) terminating the communications link between the measurement device and a central information-processing system;
b) performing steps a) i) through a) vi) for a second individual; and
c) creating, in the central information-processing system, a first invoice including a first billing charge for the physiological measurement of the first individual and a second billing charge for the physiological measurement of the second individual, wherein the invoice includes delivery information correlated to the information identifying the measurement device.

2. Apparatus according to claim 1, wherein the computer system is programmed to carry out the further method of:
d) after obtaining a predetermined number of physiological measurements of individuals into the measurement device, blocking one or more functions of the measurement device until information is transferred to the central information-processing system; and
e) once information is transferred to the central information-processing system, re-enabling the one or more functions of the measurement device.

3. Apparatus according to claim 1, wherein the measurement device further includes an arterial-pulse-pressure sensor, wherein the digitized physiological measurement includes a digitized arterial-pulse-pressure waveform and one or more calculated compliance parameters, based on the arterial-pulse-pressure waveform, for a model of the vascular system of a human.

4. Apparatus according to claim 1, further including a plurality of measurement devices, wherein computer system is programmed to carry out the further method of:
d) creating, in the central information-processing system, a separate invoice for each one of the plurality of measurement devices, each invoice including a billing charge and a patient identification for each physiological measurement.

5. A computerized system for uploading information to an information-processing system, the computerized system comprising:
a first machine that includes:
an input port operable to obtain digital information about a first consumer;
an analyzer operable to automatically analyze the digital information to generate a first analysis report for the first consumer, based on the digital information; and
an upload communications port operable to automatically, based on the generation of the first analysis report, establish a communications link to the information-processing system and to upload information from the first analysis report to the information-processing system, and then to disconnect the communications link.

6. The system according to claim 5, further comprising:
an arterial-pulse-pressure sensor operably coupled to the input port in the first machine, and wherein the digital information includes a digitized arterial-pulse-pressure waveform, and the first analysis report includes one or more calculated compliance parameters, based on the arterial-pulse-pressure waveform, for a model of the vascular system of a human, and the uploaded information includes the one or more calculated compliance parameters.

7. The system according to claim 5, fuirther comprising:
an information-processing system configured to establish the communications link in response to a request from the first machine and to receive the upload information from the first analysis report to the information-processing system, and to generate a first invoice associated with the first machine for use of the first machine.

8. The system according to claim 5, further comprising:
an information-processing system; and
a second machine that includes:
an input port operable to obtain digital information about a second consumer;
an analyzer operable to automatically analyze the digital information to generate a second analysis report for the second consumer, based on the digital information; and
an upload communications port operable to automatically, based on the generation of the second analysis report, establish a communications link to the information-processing system and to upload information from the second analysis report to the information-processing system, and then to disconnect the communications link,
wherein the information-processing system is configured to establish the communications link in response to a request from the first machine and to receive the upload information from the first analysis report to the information-processing system and to generate a first invoice associated with the first machine for use of the first machine, and to establish the communications link in response to a request from the second machine and to receive the upload information from the second analysis report to the information-processing system and to generate a second invoice associated with the second machine for use of the second machine.

9. A method comprising:
establishing a first temporary communications link in response to a request from a first remote machine;
receiving upload information from the first remote machine to the information-processing system, the upload information including a first analysis report generated by the first machine;
disconnecting the first communications link;
establishing a second temporary communications link in response to a request from a second remote machine;
receiving upload information from the second remote machine to the information-processing system, the upload information including a second analysis report generated by the second machine;
disconnecting the second communications link;
aggregating the information of the first analysis report and the information of the second analysis report for an overall analysis;
generating a first invoice associated with the first machine for use of the first machine; and
generating a second invoice associated with the second machine for use of the second machine.

10. The method of claim 9, further comprising:
sensing a first arterial pulse pressure waveform of a first person and storing a digitized representation of the first arterial pulse pressure waveform in the first remote machine;
analyzing the digitized representation of the first arterial pulse pressure waveform to calculate one or more compliance parameters, based on the arterial pulse pressure waveform, for a model of the first person's vascular system wherein the upload information from the first remote machine includes the one or more compliance parameters of the first person;
sensing a second arterial pulse pressure waveform of a second person and storing a digitized representation of the second arterial pulse pressure waveform in the second remote machine; and
analyzing the digitized representation of the second arterial pulse pressure waveform to calculate one or more compliance parameters, based on the arterial pulse pressure waveform, for a model of the second person's vascular system wherein the upload information from the second remote machine includes the one or more compliance parameters of the second person.

11. A computer system programmed to carry out the method of claim 10.

12. A computerized method for billing for analysis services comprising:
a) obtaining digital information for a first consumer into a first analysis system;
b) analyzing the digital information in the first analysis system to produce an analysis report for the first consumer;
c) establishing communications between the first analysis system and an information-processing system;
d) uploading information from the analysis report from the first analysis system to the information-processing system; and
e) generating, in the information-processing system, a first invoice for one or more charges associated with use of the first analysis system.

13. The method according to claim 12, frrther comprising:
f) obtaining digital information for a second consumer into a second analysis system;
g) analyzing the digital information in the second analysis system to produce an analysis report for the second consumer;
h) establishing communications between the second analysis system and the information-processing system;
i) uploading information from each of the one or more analysis reports from the second analysis system to the information-processing system; and
j) generating, in the information-processing system, a second invoice for charges associated with use of the second analysis system.

14. The method according to claim 13, wherein the digital information further includes demographic information regarding, and a representation of an arterial pulse pressure waveform of, each one of the respective consumers, and the analysis report includes one or more calculated compliance parameters, based on the arterial pulse pressure waveform, for a model of the vascular system of a human, the method further comprising:
k) generating, in the information-processing system, a summary report that shows an analysis combining information uploaded from the analysis report from the first analysis system with information uploaded from the analysis report from the second analysis system.

15. The method according to claim 12, wherein the digital information includes a representation of an arterial pulse pressure waveform of a person, and the analysis report includes one or more calculated compliance parameters, based on the arterial pulse pressure waveform, for a model of the vascular system of the person.

16. The method according to claim 12, wherein the digital information represents an arterial pulse pressure waveform of a person, and the analysis report includes a representation of the arterial pulse pressure waveform.

17. The method according to claim 12, wherein the first invoice includes an identifier for the first consumer and an associated charge for their use of the first analysis system.

18. The method according to claim 12, wherein the digital information represents an arterial pulse pressure waveform, and the analysis report includes one or more calculated compliance parameters, based on the arterial pulse pressure waveform, for a model of the vascular system of a person, and wherein the first invoice includes an identifier for the first consumer and an associated charge for their use of the first analysis system.

19. The method according to claim 12, the method further comprising:
l) disabling one or more functions of the first analysis system after a predetermined amount of use of the first analysis system; and
m) re-enabling the one or more functions of the first analysis system upon successful completion of uploading of the information from the first analysis system to the information-processing system.

20. A computerized system for billing for analysis services comprising:
an analysis system that analyzes digitized physiological information to produce an analysis report for each of one or more persons; and
means for generating an invoice for one or more charges associated with use of the analysis system.

21. Apparatus for gathering and analyzing a digitized physiological measurement comprising:
a reception device that receives data sent from each of a plurality of remote measurement devices, the data including at least one measurement taken by each respective remote device;
a database operatively coupled to the reception device and configured to store a plurality of measurement records, each one of the records corresponding to one or more individual measurements; and
an invoicing system operatively coupled to obtain records from the database and operable to create a first invoice including a first billing charge for a first measurement taken by a first remote measurement device and a second billing charge for a second measurement take by a second remote measurement, wherein each invoice includes delivery information correlated to information identifying the respective first or second measurement device.
